(19) United States
(12) Patent Application Publication
(10) Pub. No.: US 2012/0089632 A1
(43) Pub. Date: Apr. 12, 2012

(54) INFORMATION TERMINAL APPARATUS, CHARACTER INPUT METHOD, AND COMPUTER-READABLE MEDIUM STORING CHARACTER INPUT PROGRAM

(75) Inventors: Tong ZHOU, Kawasaki (JP); Tarq YAMADA, Kawasaki (JP)

(73) Assignee: FUJITSU LIMITED, Kawasaki-shi (JP)

(21) Appl. No.: 13/194,226

(22) Filed: Jul. 29, 2011

(30) Foreign Application Priority Data
Oct. 6, 2010 (JP) 2010-226369

(51) Int. Cl. G06F 17/30

(52) U.S. Cl. 707/769; 707/E17.039

(57) ABSTRACT

An information terminal apparatus is provided with a storage unit and a search unit. The storage unit stores information on a plurality of character strings and information on the pronunciation and shape of each of the characters included in the plurality of character strings. The search unit receives a first input representing part or all of one of the pronunciation and shape of a character, and retrieves possible character strings which have a first character matching the first input. The search unit then receives a second input representing part or all of the other of the pronunciation and shape of a character, and extracts possible character strings which further have a second character matching the second input, from the possible character strings retrieved in response to the first input.

### CROSS-REFERENCE TO RELATED APPLICATIONS

This application is based upon and claims the benefits of priority of the prior Japanese Patent Application No. 2010-226369, filed on Oct. 6, 2010, the entire contents of which are incorporated herein by reference.

### FIELD

The embodiments discussed herein are related to an information terminal apparatus, a character input method, and a computer-readable medium storing a character input program.

### BACKGROUND

There are times when a user enters characters (ideograms or logograms) like Chinese characters other than phonogram characters in an information terminal apparatus. Such the information terminal apparatus may be a portable telephone or electronic dictionary device.

To enter a character other than phonogram characters, the user specifies symbols (phonetic symbols) corresponding to the pronunciation of the character or specifies the shape of the character. In the pronunciation-based input, for example, the user specifies phonetic symbols by pressing keys using a keypad. Phonetic symbols may be Pinyin or Bopomofo for Chinese input and may be Kana or Roman letters for Japanese input. In the shape-based input, on the other hand, the user may specify the shape of a character by drawing on a touch panel.

Also, the user occasionally enters a phrase made up of a plurality of characters other than phonogram characters, in addition to entering only one character other than phonogram characters.

There has been proposed a phrase input method in which, when an alphabetical letter is specified, possible Chinese characters whose Pinyin beings with the specified alphabetical letter are retrieved, and when an intended Chinese character is selected, phrases that begin with the selected Chinese character are displayed (for example, refer to Japanese Laid-open Patent Publication No. 2007-188449, paragraphs [0102] to [0109] and [0115]). In addition, there has been proposed another phrase input method in which, when the first Pinyin letter of each of the first and second Chinese characters of a phrase is specified, and then the first stroke of the first Chinese character is drawn, phrases which satisfy these conditions are displayed (for example, refer to Japanese Laid-open Patent Publication No. 11-328312, paragraph [0066]).

These character string input methods, as disclosed in the above Japanese Laid-open Patent Publications Nos. 2007-188449 and 11-328312, still leave room for improvement, such as reducing user's operational burden.

For example, the method disclosed in Japanese Laid-open Patent Publication No. 2007-188449 needs a user operation to select and determine the first Chinese character of an intended phrase from possible Chinese characters, and then another user operation to, after possible phrases are displayed, select the intended phrase from the possible phrases. At this time, there may be many possible Chinese characters or phrases displayed, which places an operational burden of finding and selecting one from many characters or phrases on the user. The method disclosed in Japanese Laid-open Patent Publication No. 11-328312, on the other hand, needs a user to take troublesome operations to specify an alphabetical letter for each of Chinese characters forming a phrase and then write the first Chinese character of the phrase.

### SUMMARY

According to an aspect of the present invention, an information terminal apparatus includes: a storage unit that stores information on a plurality of character strings and information on a pronunciation and shape of each of a plurality of characters included in the plurality of character strings; and a search unit that receives a first input representing part or all of one of a pronunciation and shape of a character, consults the storage unit to retrieve possible character strings which have a first character matching the first input, receives a second input representing part or all of another of a pronunciation and shape of a character, and extracts possible character strings which further have a second character matching the second input, from the possible character strings retrieved in response to the first input.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an information terminal apparatus according to a first embodiment;

FIG. 2 illustrates an appearance of a portable telephone according to a second embodiment;

FIG. 3 is a block diagram illustrating a configuration of the portable telephone;

FIG. 4 is a block diagram for a character input function of the portable telephone;

FIG. 5 illustrates an example data structure of a Chinese character dictionary;

FIG. 6 is a flowchart of a character input process;

FIGS. 7 and 8 illustrate a first example of character input;

FIGS. 9 and 10 illustrate a second example of character input;

FIG. 11 illustrates a third example of character input;

FIG. 12 illustrates a fourth example of character input; and

FIGS. 13 and 14 illustrate a fifth example of character input.

### DESCRIPTION OF EMBODIMENTS

Embodiments of the present invention will now be described with reference to the accompanying drawings, wherein like reference numerals refer to like elements throughout.

### First Embodiment

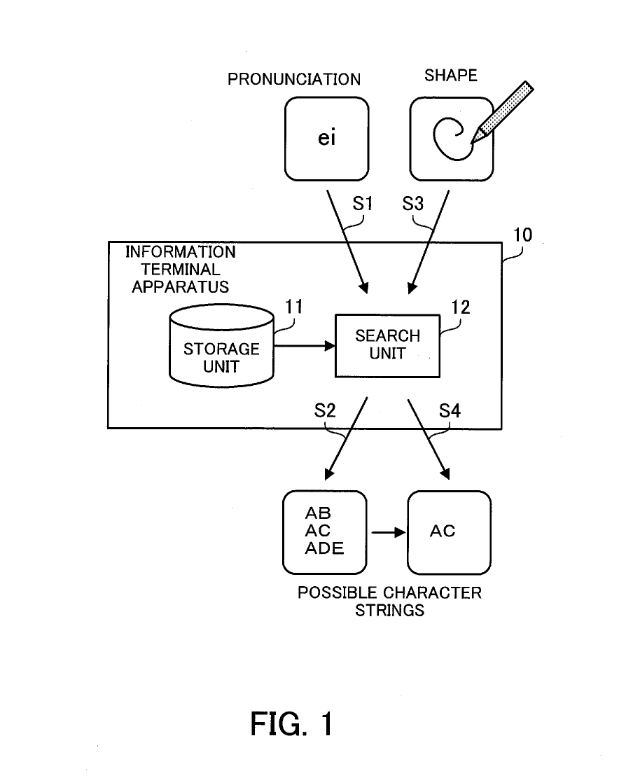

FIG. 1 illustrates an information terminal apparatus according to a first embodiment.

An information terminal apparatus 10 according to the first embodiment assists a user in entering character strings. Specific examples of the information terminal apparatus 10 include portable telephones, electronic dictionary devices, and Personal Digital Assistants (PDA). For entering character strings, the information terminal apparatus 10 may be provided with an input device such as a touch panel or keypad and an output device such as a liquid crystal display. The information terminal apparatus 10 includes a storage unit 11 and a search unit 12.

The storage unit 11 stores information on the pronunciations and shapes of a plurality of characters and information on character strings. The characters are ones (ideograms or logograms) like Chinese characters other than phonogram characters. The pronunciation information may be phonetic symbols such as Pinyin or Bopomofo. The shape information may be image data or characteristic information representing the characteristics of a shape. Character strings include phrases that are made up of a plurality of characters other than phonogram characters. The information on a character string may be information that defines a plurality of characters included in the character string and the order of the characters in the character string.

The search unit 12 receives a first input representing part or all of one of the pronunciation and shape of a character. As a phonetic input, part or all of the phonetic symbols of a character may be inputted using a keypad or touch panel. As a shape input, part or all of the shape of a character, such as a radical, may be drawn on a touch panel.

Upon receipt of the first input, the search unit 12 consults the storage unit 11 to search for a first character matching the first input, and retrieves possible character strings which have the first character. For example, in response to a first input representing a pronunciation, the search unit 12 searches for a character the phonetic symbols of which are a partial or full match to the phonetic symbols specified by the first input. In response to a first input representing a shape, on the other hand, the search unit 12 carries out matching between the contents of the first input and image data or characteristic information, in order to search for a character which has a matching level exceeding a predetermined threshold. If a plurality of first characters is found, the search unit 12 may retrieve possible character strings for each of the first characters.

Then, the search unit 12 receives a second input representing part or all of the other (i.e., the one different from the first input) of the pronunciation and shape of a character. Upon receipt of the second input, the search unit 12 searches for a second character matching the second input, similarly to searching for the first character, and extracts possible character strings which further have the second character, from the possible character strings retrieved in response to the first input. That is to say, the possible character strings having the first character are narrowed down by using the second character different from the first character.

In this connection, the search unit 12 is able to retrieve only possible character strings which have the first character at a specified position (for example, at the first position) in response to the first input. Similarly, the search unit 12 is able to extract only possible character strings which have the second character at a specified position (for example, at the second position) in response to the second input. In addition, the information terminal apparatus 10 may display the possible character strings retrieved in response to the first input, on a display device provided in the information terminal apparatus 10, and then display the possible character strings extracted in response to the second input, instead of or along with the possible character strings retrieved in response to the first input, on the display device.

As described above, upon receipt of a first input representing part or all of one of the pronunciation and shape of a character, such an information terminal apparatus 10 consults the storage unit 11 to retrieve possible character strings which have a first character matching the first input. After that, upon receipt of a second input representing part or all of the other of the pronunciation and shape of a character, the information terminal apparatus 10 extracts possible character strings which further have a second character matching the second input, from the possible character strings retrieved in response to the first input.

As one example, the information terminal apparatus 10 is able to assist in entering a character string as follows. When receiving a first input representing part or all of a pronunciation (step S1), the information terminal apparatus 10 retrieves possible character strings that begin with a first character matching the first input, and proposes them to a user (step S2). Then, when receiving a second input representing part or all of a shape (step S3), the information terminal apparatus 10 narrows down the possible character strings to ones that further have next to the first character a second character matching the second input, and proposes them to the user (step S4). As another example, the information terminal apparatus 10 may receive a first input representing part or all of a shape and then receive a second input representing part or all of a pronunciation.

The above approach reduces a user's operational burden to enter a character string, and realizes trouble-free input of character strings. That is to say, a user is able to enter a character sting by specifying characters with both phonetic input and shape input. Even if the user does not clearly remember the pronunciation or shape of each character included in a character string, the user is able to efficiently narrow down possible character strings.

Further, possible character strings which have a first character are retrieved in response to an input of the pronunciation (or shape) of a first character, and then the possible character strings are narrowed down in response to an input of the shape (or pronunciation) of a second character, meaning that the user is able to naturally narrow down possible character strings stepwise. For example, if not many possible character strings are retrieved in response to a first input, the user may select an intended character string, omitting a second input. Further, even if the first and second inputs are so ambiguous as to extract multiple possible first and second characters, possible character strings which satisfy these conditions are retrieved, thereby reducing the user's operational burden.

The storage unit 11 and search unit 12 may be implemented as dedicated hardware components or realized by causing a computer provided with a processor and general-purpose memory to execute a predetermined character input program. In addition, information on characters and character strings may be stored in the storage unit 11, in advance or by the information terminal device 10 acquiring it over a network. In a second embodiment to be described below, a portable telephone provided with a processor and general-purpose memory executes a character input program to assist a user in entering character strings.

### Second Embodiment

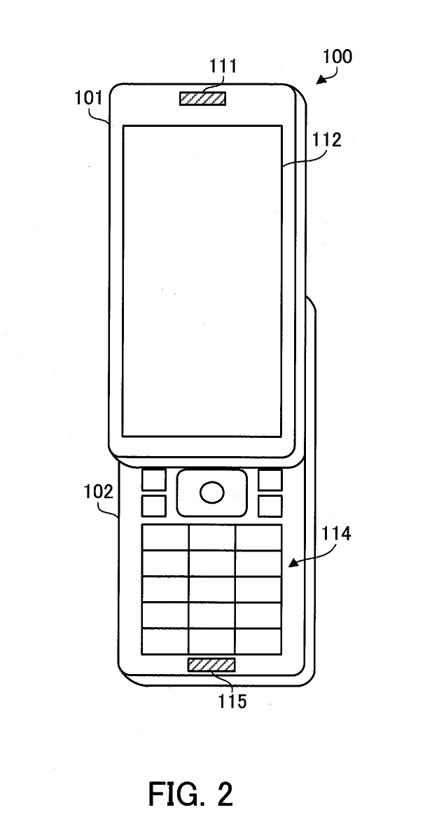

FIG. 2 illustrates an appearance of a portable telephone according to the second embodiment. The illustrated portable telephone 100 allows a user to enter a Chinese character through both key operation and touch operation, and is considered as one example of the information terminal apparatus 10 of the first embodiment. The portable telephone 100 is provided with cases 101 and 102, a speaker 111, display 112, keypad 114, and microphone 115.

The case 101 is mounted on the top surface (surface facing the user) of the case 102, and is slidable on the case 102 in a longitudinal direction. In a first state, the case 101 covers the whole top surface of the case 102, with the sides of the case 101 aligned with the sides of the case 102. In a second state where the case 101 is slid, the case 101 covers about a half of the top surface of the case 102, the remaining part of the top surface of the case 102 is exposed.

The case 101 is provided with the speaker 111 and display 112 on the top surface thereof. The case 102 is provided with the keypad 114 and microphone 115 on the lower half side of the top surface thereof. These keypad 114 and microphone 115 are covered by the case 101 in the first state and are exposed in the second state. Signals are sent and received between the cases 101 and 102 by wire or wireless.

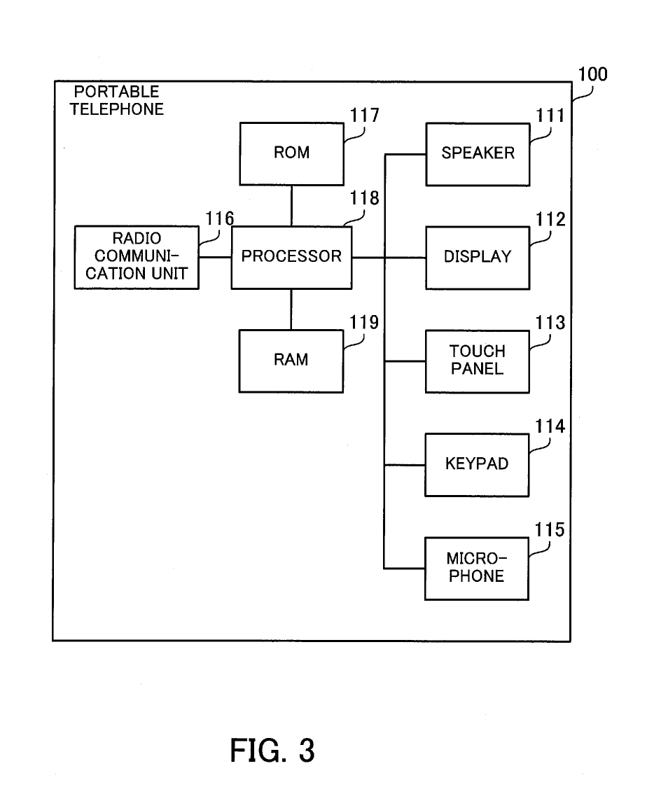

FIG. 3 is a block diagram illustrating a configuration of a portable telephone. The portable telephone 100 has a touch panel 113, radio communication unit 116, a Read Only Memory (ROM) 117, processor 118, and Random Access Memory (RAM) 119, in addition to the above-mentioned speaker 111, display 112, keypad 114, and microphone 115. The radio communication unit 116, ROM 117, processor 118, and RAM 119 may be provided in the case 101 or in the case 102.

The speaker 111 reproduces sounds by converting an electrical audio signal into physical movements under the control of the processor 118. For example, while a user communicates by using the portable telephone 100, the communication party's voice and background noise of the communication party side are output from the speaker 111.

The display 112 displays various screens including an operation screen for entering Chinese characters, under the control of the processor 118. As the display 112, a liquid crystal display or an organic Electro Luminescence (EL) display may be employed. The display 112 is mounted under the touch panel 113, so that the user views a display screen through the touch panel 113.

The touch panel 113 senses a user's touch operation, and outputs an input signal indicating the touch position to the processor 118. The user's touch operation is made by using a pointing device such as a touch pen or user's finger. The user is able to touch the touch panel 113 while viewing a screen displayed on the display 112. For sensing a touch position, there are various kinds of methods, for instance, a matrix switching method, resistive film method, surface acoustic wave method, infrared rays method, electromagnetic induction method, electrostatic capacity method, and any one of them may be employed.

The keypad 114 is provided with a plurality of input keys. By a user pressing an input key, the keypad 114 outputs an input signal indicating the pressed input key to the processor 118. Assignment of characters to the input keys is managed by the processor 18. For example, numerals, alphabetical letters, Kana characters, and other symbols are assigned to the input keys. Some input keys may be used as function keys for starting and ending communication or for starting and ending input of characters.

The microphone 115 receives an audio input by converting physical movements of sounds into an electrical signal, and outputs the obtained electrical audio signal to the processor 118. For example, while the user communicates, user' voice and background noise of the user side are input to the microphone 115.

The radio communication unit 116 performs radio communication with a wireless communication apparatus such as a wireless base station, under the control of the processor 118. For example, the radio communication unit 116 demodulates and decodes a radio signal received via an antenna, which is provided in the portable telephone 100, and outputs the obtained received data to the processor 118. The radio communication unit 116 also codes and modulates transmit data received from the processor 118, and outputs the obtained transmit signal via the antenna.

The ROM 117 is a storage medium that previously stores programs to be executed by the processor 118, and data which is used while the programs run. The programs stored in the ROM 117 include a character input program for assisting the user in entering Chinese characters. Data stored in the ROM 117 includes a Chinese character dictionary. Instead of the ROM 117, a rewritable non-volatile memory such as a flash memory may be employed.

The processor 118 reads at least part of a program and data from the ROM 117, and puts them in the RAM 119 to execute the program. Thereby, the processor 118 is able to control the entire operation of the portable telephone 100. In the case where a rewritable non-volatile memory is used instead of the ROM 117, the processor 118 may be designed to acquire a latest Chinese character dictionary via the radio communication unit 116 over the network and update the Chinese character dictionary in the non-volatile memory. As the processor 118, a Central Processing Unit (CPU) or Micro Processing Unit (MPU) may be employed, for example.

The RAM 119 is a volatile memory that temporarily stores a program to be executed by the processor 118 and at least part of data which is used while the program runs. The processor 118 appropriately reads/writes data from the RAM 119. Instead of the RAM 119, another kind of memory may be employed.

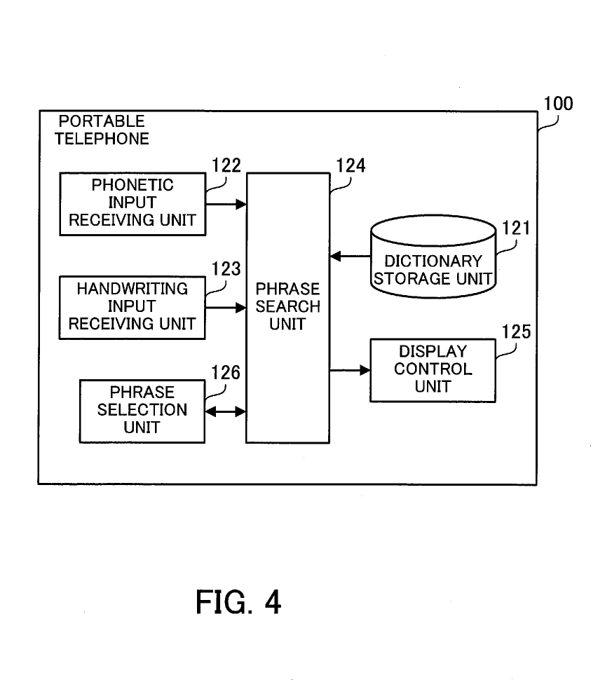

FIG. 4 is a block diagram for a character input function of a portable telephone. By the processor 118 executing a character input program, the portable telephone 100 realizes a dictionary storage unit 121, a phonetic input receiving unit 122, a handwriting input receiving unit 123, a phrase search unit 124, a display control unit 125, and a phrase selection unit 126.

The dictionary storage unit 121 stores a Chinese character dictionary that the phrase search unit 124 searches. The Chinese character dictionary includes information on phrases, each made up of two or more Chinese characters, and information on the pronunciation and shape of each of Chinese characters included in each phrase. The dictionary storage unit 121 is a data region saved in the RAM 119.

The phonetic input receiving unit 122 receives information representing part (first symbol or first some symbols) or all of the phonetic symbols of one Chinese character inputted by the user with the keypad 114. To enter a simplified Chinese character, the Pinyin system may be used. To enter a traditional Chinese character, the Bopomofo system may be used. To enter a simplified Japanese character, the Kana or Roman letter system may be used. The phonetic input receiving unit 122 supplies the phrase search unit 124 with the received contents.

The handwriting input receiving unit 123 receives information representing part or all of the shape of one Chinese character inputted by the user on the touch panel 113. The shape to be received is the one that characterizes a Chinese character, such as the shape of a radical or the shape of a component part of the Chinese character. The handwriting input receiving unit 123 supplies the phrase search unit 124 with the received contents. In this connection, the touch panel 113 may be used for inputting the phonetic symbols of a Chinese character. For example, the user uses the touch panel 113 to specify phonetic symbols by writing thereon or touching the images of input keys displayed on the display 112.

The phrase search unit 124 searches the Chinese character dictionary for phrases satisfying the conditions based on the contents of phonetic symbols received from the phonetic input receiving unit 122 and the contents of the shape received from the handwriting input receiving unit 123. Then, the phrase search unit 124 supplies the display control unit 125 with the extracted phrases (possible phrases).

The phrase search unit 124 is designed to be able to predict a phrase to be entered and narrow down possible phrases stepwise. More specifically, when part or all of the phonetic symbols or shape of the first Chinese character of a phrase is inputted, possible phrases that begin with a Chinese character satisfying this condition are retrieved. Then, when part or all of the phonetic symbols or shape of the second Chinese character of the phrase is inputted, possible phrases which further satisfy the condition for the second character are extracted from the possible phrases satisfying the condition for the first character, thereby narrowing down the possible phrases. A phrase search method will be described in detail later.

The display control unit 125 generates an operation screen for entering a phrase, and displays the screen on the display 112. By the user selecting a phonetic-based character input method, the display control unit 125 displays an input box for input of phonetic symbols. By the user selecting a shape-based character input method, the display control unit 125 displays an input space for handwriting of a shape. The display control unit 125 also displays possible phrases received from the phrase search unit 124 on the display 112.

The phrase selection unit 126 senses a user's operation of selecting a phrase from the possible phrases displayed on the display 112. The user selects the phrase through the touch operation using the touch panel 113 or the key operation using the keypad 114. The phrase selection unit 126 determines the user's selected phrase as a character string to be entered.

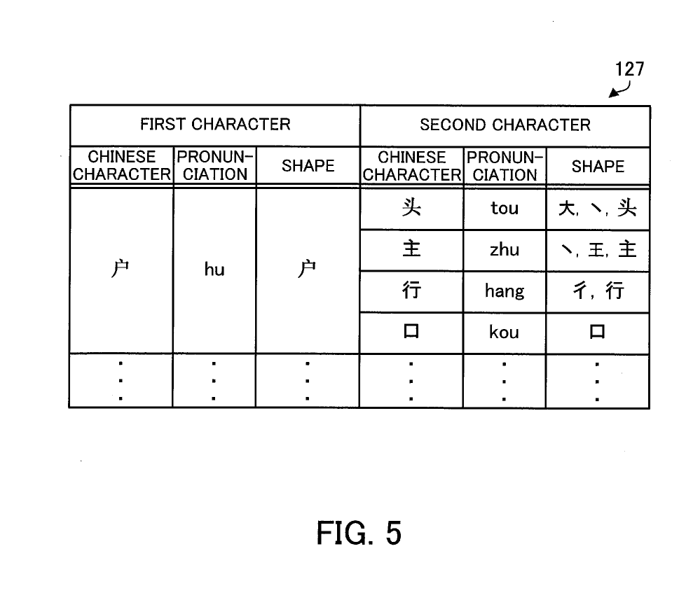

FIG. 5 illustrates an example data structure of a Chinese character dictionary. The illustrated Chinese character dictionary 127 is stored in the dictionary storage unit 121. The Chinese character dictionary 127 stores information on the first Chinese characters (first characters) of phrases and information on the second Chinese characters (second characters) of the phrases in association with each other.

The information on the first or second character of a phrase includes information identifying a Chinese character, information on pronunciation, and information on shape. For example, character codes of Chinese characters may be used as the information identifying a Chinese character. A sequence of character codes corresponding to phonetic symbols may be used as the information on pronunciation. And, image data representing a shape or a value representing the characteristics of the shape calculated by a predetermined evaluation formula may be used as the information on shape. In addition to the image data or characteristic value of the whole Chinese character, the information on shape also includes image data or characteristic value of part of the Chinese character so as to search for the Chinese character on the basis of a partial shape of the Chinese character such as a radical.

For example, upon receipt of phonetic symbols from the phonetic input receiving unit 122, the phrase search unit 124 retrieves Chinese characters the phonetic symbols of which begin with the specified phonetic symbols (prefix match) from the Chinese character dictionary 127. Upon receipt of information on shape from the handwriting input receiving unit 123, the phrase search unit 124 carries out pattern matching between the specified shape and the image data, and retrieves Chinese characters image data of which have a matching level exceeding a predetermined threshold. Alternatively, the phrase search unit 124 may calculate a characteristic value of the specified shape, compare it with the characteristic values stored in the Chinese character dictionary 127, and retrieve Chinese characters which have a difference in characteristic value lower than a predetermined threshold. In comparing such shapes, a stroke order (user's stroke order) may be or may not be taken into consideration.

FIG. 5 depicts just an example data structure, and another data structure is considered for a Chinese character dictionary. For example, information on the pronunciations and shapes of Chinese characters and information on phrases (that is, information on Chinese characters included in a phrase and the order of the Chinese characters in the phrase) may be separately stored. Further, the character dictionary 127 lists phrases, each made up of two Chinese characters. However, phrases, each made up of three or more Chinese characters, may be listed. In this case, information on each of the three or more Chinese characters may be stored in association with each other in the Chinese character dictionary 127.

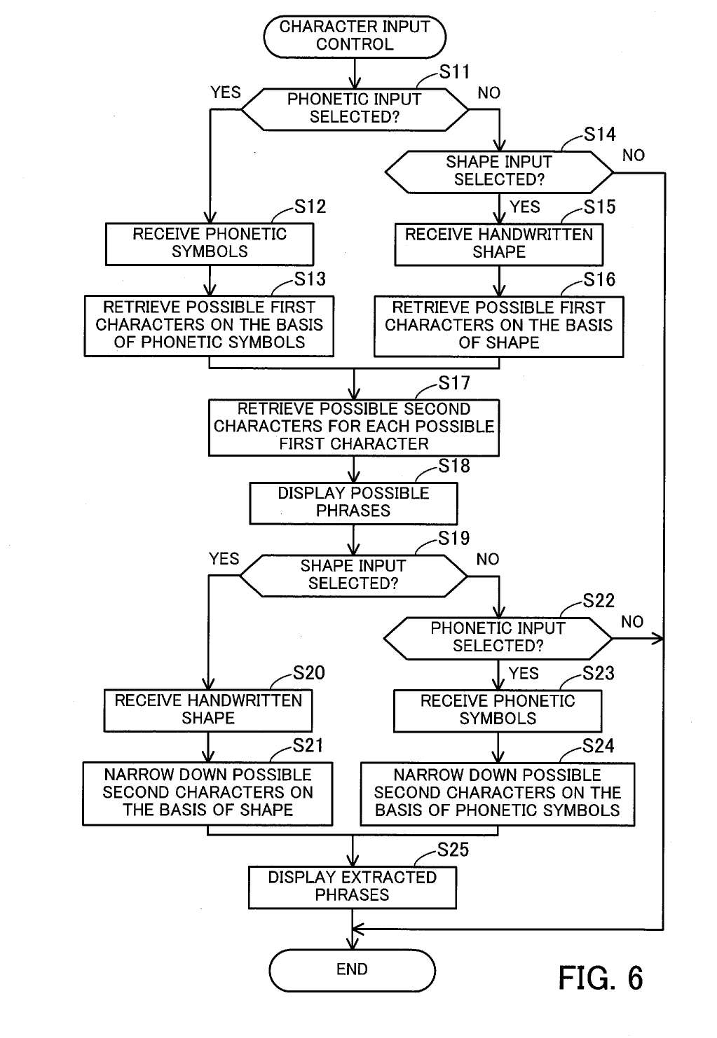

A flow of a character input process to be executed by the portable telephone 100 will now be described with reference to FIG. 6. This process will be described step by step.

At step S11, the phrase search unit 124 determines whether a phonetic-based input method has been selected as a method of specifying the first Chinese character of a phrase. If the phonetic-based input method has been selected, the process proceeds to step S12. Otherwise, the process proceeds to step S14.

At step S12, the display control unit 125 displays an input box for input of phonetic symbols on the display 112. The phonetic input receiving unit 122 receives phonetic symbols inputted using the keypad 114, as a search condition for the first Chinese character of a phrase.

At step S13, the phrase search unit 124 retrieves possible Chinese characters matching the phonetic symbols inputted at step S12, from the Chinese characters listed as first characters in the Chinese character dictionary 127. In this connection, a plurality of possible first characters matching the inputted phonetic symbols may be retrieved. Then, the process proceeds to step S17.

At step S14, the phrase search unit 124 determines whether a shape-based input method has been selected as a method of specifying the first Chinese character of a phrase. If the shape-based input method has been selected, the process proceeds to step S15. Otherwise, the process is terminated.

At step S15, the display control unit 125 displays an input space for handwriting of a shape on the display 112. The handwriting input receiving unit 123 receives information on the handwritten shape drawn on the touch panel 113, as a search condition for the first Chinese character of a phrase.

At step S16, the phrase search unit 124 retrieves possible Chinese characters matching the shape inputted at step S15, from the Chinese characters listed as first characters in the Chinese character dictionary 127. In this connection, a plurality of possible first characters matching the inputted shape may be retrieved.

At step S17, with respect to each of the possible first characters retrieved at step S13 or S16, the phrase search unit 124 retrieves a possible second character that follows the possible first character, from the Chinese character dictionary 127. In this connection, a plurality of possible second characters may be retrieved for each possible first character. The phrase search unit 124 may sort the plurality of retrieved possible second characters according to predetermined item (for example, use frequency).

At step S18, the display control unit 125 displays the possible first characters retrieved at step S13 or S16 and the possible second characters retrieved at step S17 on the display 112. That is to say, information indicating possible phrases satisfying the condition for the first Chinese character is displayed on the display 112.

At step S19, the phrase search unit 124 determines whether a shape-based input method has been selected as a method for specifying the second Chinese character of the phrase. If the shape-based input method has been selected, the process proceeds to step S20. Otherwise, the process proceeds to step S22.

At step S20, the display control unit 125 displays an input space for handwriting of a shape on the display 112. The handwriting input receiving unit 123 receives the information on the shape inputted using the touch panel 113, as a search condition for the second Chinese character of the phrase.

At step S21, the phrase search unit 124 extracts possible second characters matching the shape inputted at step S20 from the possible second characters retrieved at step S17. Thereby, the possible phrases satisfying the condition for the first Chinese character are narrowed down on the basis of the condition for the second Chinese character. Then, the process proceeds to step S25.

At step S22, the phrase search unit 124 determines whether a phonetic-based input method has been selected as a method of specifying the second Chinese character of the phrase. If the phonetic-based input method has been selected, the process proceeds to step S23. Otherwise, the process is terminated.

At step S23, the display control unit 125 displays an input box for input of phonetic symbols on the display 112. The phonetic input receiving unit 122 receives phonetic symbols inputted using the keypad 114, as a search condition for the second Chinese character of the phrase.

At step S24, the phrase search unit 124 extracts possible second characters matching the shape inputted at step S23 from the possible second characters retrieved at step S17.

At step S25, the display control unit 125 displays the possible second characters extracted at step S21 or S24 and the possible first characters followed by the possible second characters in phrases, on the display 112. That is to say, information indicating possible phrases which satisfy the conditions for both the first Chinese character and the second Chinese character is displayed on the display 112.

As described above, by inputting a condition for the first Chinese character of a phrase, the user is able to display possible first Chinese characters, which satisfy the condition, and possible second Chinese characters that follow the first Chinese characters. If there are not many combinations of the first and second characters (i.e., possible phrases) retrieved, the user may select an intended phrase from the displayed possible phrases, omitting further input of a condition for the second Chinese characters. On the other hand, when the user further inputs a condition for the second Chinese character of the phrase, the displayed possible phrases are narrowed down to those further satisfying the condition for the second Chinese character. The user is then able to select an intended phrase from the remaining possible phrases.

In addition, the user is able to select a method for specifying a condition for the first character of a phrase and a method for specifying a condition for the second character of the phrase independently. That is to say, the user is able to specify part or all of the phonetic symbols of a Chinese character as a condition for the first character, and specify part or all of a shape as a condition for the second character. Alternatively, the user is also able to specify part or all of a shape as a condition for the first character, and specify part or all of the phonetic symbols of a Chinese character as a condition for the second character.

The above-described character input process lets the user specify a condition for the first Chinese character of a phrase, and then specify a condition for the second Chinese character of the phrase. However, an order of setting conditions for Chinese characters of a phrase does not need to follow the order or positions of the Chinese characters of the phrase. For example, a condition for the second Chinese character of a phrase may be first specified, and then a condition for the first Chinese character of the phrase may be specified. If an intended phrase is made up of three or more Chinese characters, a condition for the second Chinese character of the phrase may be specified first, and then a condition for the third Chinese character of the phrase may be specified. In the above explanation, the user specifies a condition for the second Chinese character of a phrase without determining the first Chinese character. Alternatively, the condition for the second Chinese character may be specified after the first Chinese character is determined.

The following describes specific examples of character input in the portable telephone 100. The following explanation does not take four tones into consideration in inputting Chinese phonetic symbols. Needless to say, phonetic symbols may be inputted with taking the four tones into consideration.

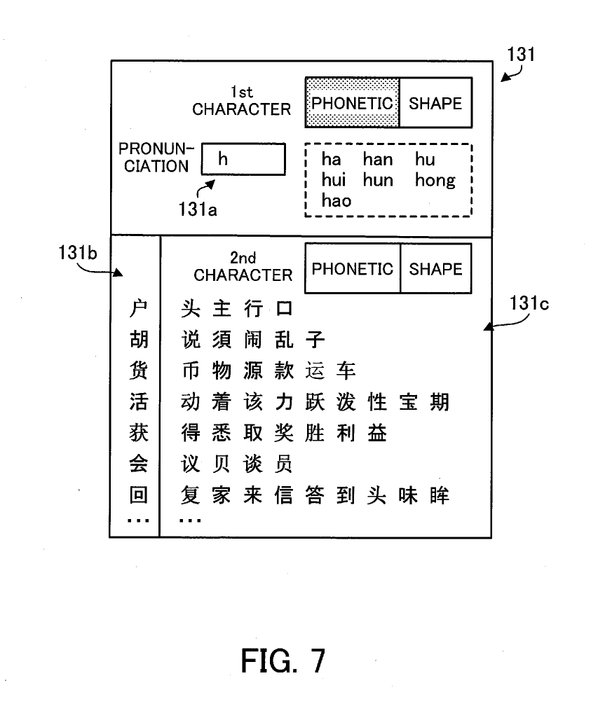

FIG. 7 illustrates a first half of a first example of character input. In this example, simplified Chinese characters are assumed to be entered. A screen 131 of FIG. 7 is an operation screen that the display control unit 125 displays on the display 112. This screen 131 has an input box 131a for input of Pinyin, a display area 131b for displaying possible first Chinese characters, and a display area 131c for displaying possible second Chinese characters in association with each possible first Chinese character.

When the user selects a Pinyin (phonetic)-based input method as a method for specifying the first Chinese character of a phrase, the input box 131a appears. When the user inputs “h” as part of the Pinyin of the first Chinese character in the input box 131a, possible Chinese characters the Pinyin of which begins with “h” are displayed in the display area 131b. In addition, possible second characters, which follow each possible first character, are displayed in the display area 131c.

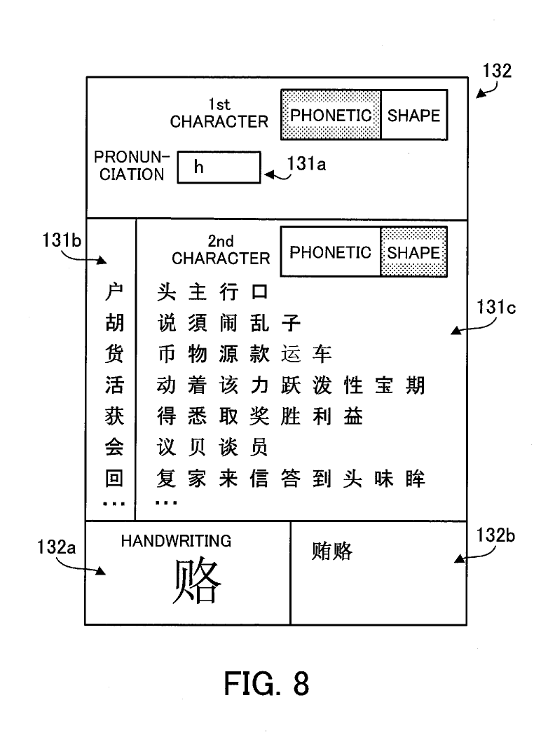

FIG. 8 illustrates a second half of the first example of character input. A screen 132 of FIG. 8 is an operation screen that the display control unit 125 displays on the display 112 after the screen 131. The screen 132 has an input space 132a for handwriting of the shape of a Chinese character and a display area 132b for displaying extracted possible phrases, in addition to the input box 131a and display areas 131b and 131c.

When the user selects a handwriting input method as a method for specifying the second Chinese character of the phrase on the screen 131, the input space 132a appears. When the user draws the shape of the second Chinese character in the input space 132a, the possible second Chinese characters displayed in the display area 131c are searched for Chinese characters having a similar shape. Then, in the display area 132b, phrases (possible phrases) which have the first Chinese character the Pinyin of which begins with “h” and also has the second Chinese character having a shape similar to that inputted in the input space 132a are displayed. Referring to FIG. 8, the whole shape of the Chinese character is drawn in the input space 132a. Alternatively, a part of the shape (for example, the shape of Kanji “shell” radical) may be drawn.

In the example of FIGS. 7 and 8, the phrase (phrase displayed in the display area 132b) that the user intends to enter has Pinyin of “hui lu”. The first Chinese character of this phrase has a shape that is hard to remember and its Pinyin is easy to be mistaken for “hiu”. In addition, the Pinyin of the second Chinese character is also easy to be mistaken for “luo”. Therefore, as illustrated in FIGS. 7 and 8, the user inputs the first letter, “h”, of the Pinyin of the first Chinese character of the phrase, and draws the shape of the second Chinese character.

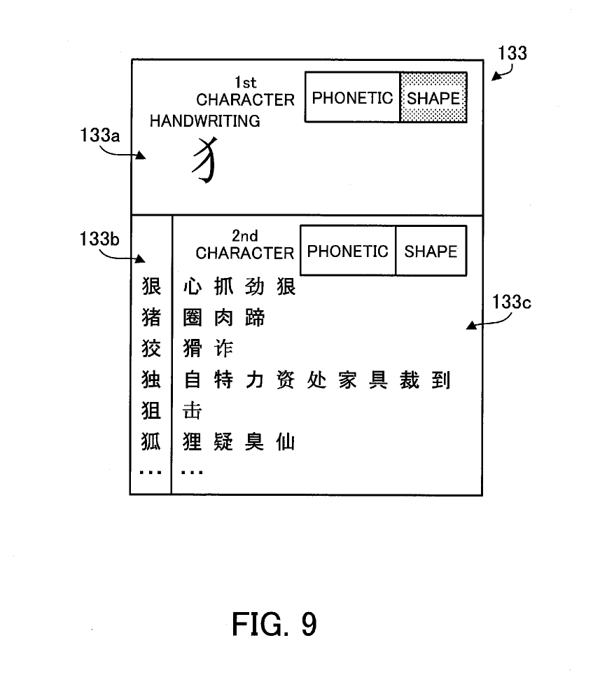

FIG. 9 illustrates a first half of a second example of character input. Similarly to the first example of character input, simplified Chinese characters are assumed to be entered in this second example. A screen 133 of FIG. 9 is an operation screen that the display control unit 125 displays on the display 112. The screen 133 has an input space 133a for handwriting of the shape of a Chinese character, a display area 133b for displaying possible first Chinese characters, and a display area 133c for displaying possible second Chinese characters in association with each possible first Chinese character.

When the user selects a handwriting input method as a method for specifying the first Chinese character of a phrase, the input space 133a appears. When the user draws the shape of Kanji “dog” radical as part of the shape of the first Chinese character in the input space 133a, Chinese characters having this shape are retrieved and displayed in the display area 133b as possible first Chinese characters. In addition, in the display area 133c, possible second Chinese characters that follow each possible first Chinese character are displayed.

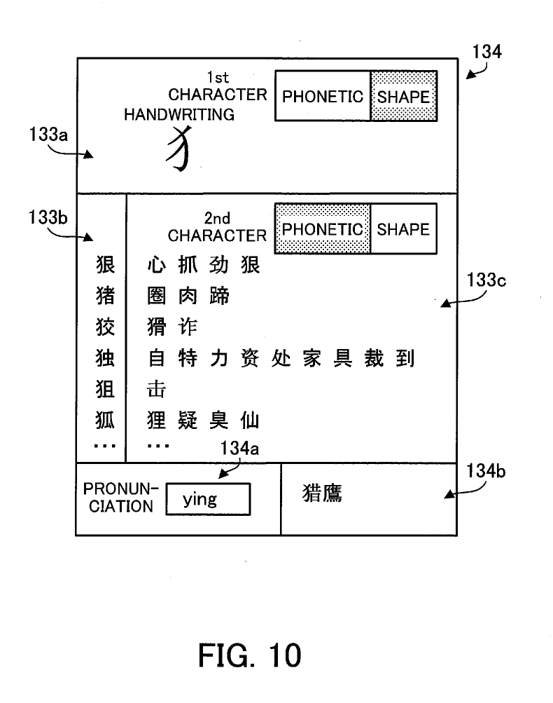

FIG. 10 illustrates a second half of the second example of character input. A screen 134 of FIG. 10 is an operation screen that the display control unit 125 displays on the display 112 after the screen 133. The screen 134 has an input box 134a for input of Pinyin and a display area 134b for displaying extracted possible phrases, in addition to the input space 133a and display areas 133b and 133c.

When the user selects a Pinyin-based input method as a method for specifying the second Chinese character of the phrase on the screen 133, the input box 134a appears. When the user inputs “ying” as the Pinyin of the second Chinese character in the input box 134a, Chinese characters having the Pinyin of “ying” are extracted from the possible second Chinese characters displayed in the display area 133c. Then, in the display area 134b, phrases (possible phrases) which have the first Chinese character with the Kanji “dog” radical and the second Chinese character with the Pinyin of “ying” are displayed. Referring to FIG. 10, the Pinyin is fully inputted in the input box 134a. However, only part of the Pinyin may be inputted.

In the example of FIGS. 9 and 10, the phrase (phrase displayed in the display area 134b) that the user intends to enter has Pinyin of “lei ying”. The first Chinese character of this phrase has Pinyin that is easy to be mistaken for “lie”. In addition, the second Chinese character is hard to write due to many strokes. Therefore, as illustrated in FIGS. 9 and 10, the user draws the shape of the radical of the first Chinese character of the phrase and inputs the Pinyin of the second Chinese character.

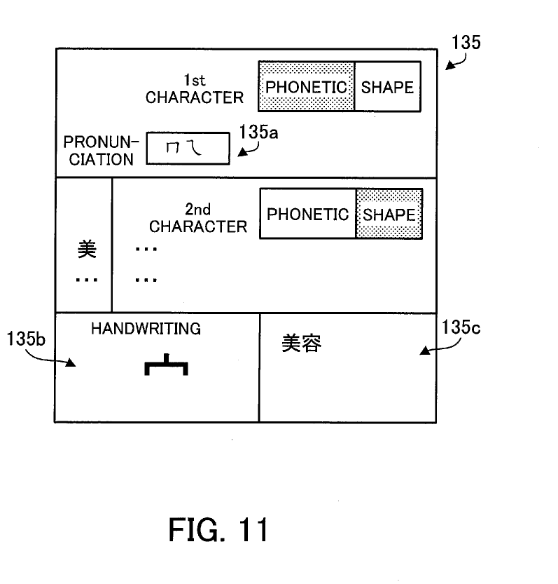

FIG. 11 illustrates a third example of character input. In this example, traditional Chinese characters are assumed to be entered. A screen 135 of FIG. 11 is an operation screen that the display control unit 125 displays on the display 112. The screen 135 has an input box 135a for input of Bopomofo (phonetic symbols), an input space 135b for handwriting of a shape, and a display area 135c for displaying extracted possible phrases.

When the user selects a Bopomofo-based input method as a method for specifying the first Chinese character of a phrase, the input box 135a appears. When the user inputs the Bopomofo of the first Chinese character in the input box 135a, Chinese characters having the inputted Bopomofo are retrieved and displayed as possible first Chinese characters. In addition, possible second Chinese characters that follow each possible first Chinese character are also displayed.

When the user selects a handwriting input method as a method for specifying the second Chinese character of the phrase, the input space 135b appears. When the user draws the shape of Kanji “roof” radical as part of the shape of the second Chinese character in the input space 135b, Chinese characters having this shape are extracted from the displayed possible second Chinese characters. Then, in the display area 135c, phrases (possible phrases) which have the first Chinese character having the Bopomofo inputted in the input box 135a and the second Chinese character having the Kanji “roof” radical are displayed.

In this connection, there are Bopomofo symbols that are similar in pronunciation to each other. In the example of FIG. 11, the second Chinese character of the phrase (phrase displayed in the display area 135c) that the user intends to enter has Bopomofo that is easy to be mistaken. Therefore, as illustrated in the example of FIG. 11, the user inputs the Bopomofo of the first Chinese character of the phrase and then writes the radical of the second Chinese character.

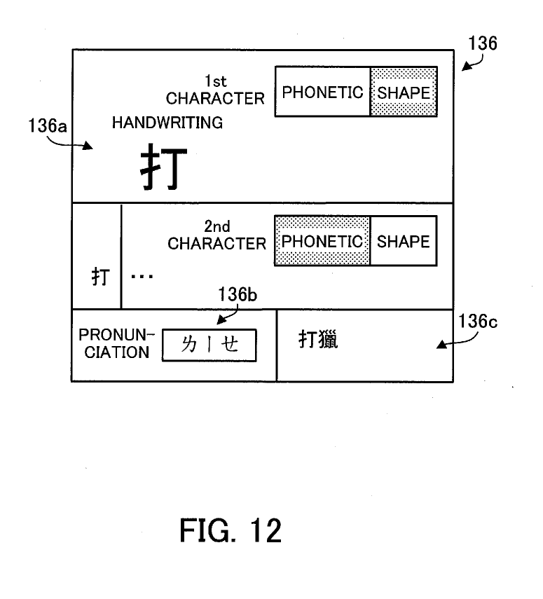

FIG. 12 illustrates a fourth example of character input. Similarly to the third example of character input, traditional Chinese characters are assumed to be entered in this example. A screen 136 of FIG. 12 is an operation screen that the display control unit 125 displays on the display 112. The screen 136 has an input space 136a for handwriting of a shape, an input box 136b for input of Bopomofo, and a display area 136c for displaying extracted possible phrases.

When the user selects a handwriting input method as a method for specifying the first Chinese character of a phrase, the input space 136a appears. When the user draws the shape of the first Chinese character in the input space 136a, Chinese characters having a shape similar to the inputted one are retrieved and displayed as possible first Chinese characters. In addition, possible second Chinese characters that follow each possible first Chinese character are also displayed.

When the user selects a Bopomofo-based input method as a method for specifying the second Chinese character of the phrase, the input box 136b appears. When the user inputs Bopomofo of the second Chinese character in the input box 136b, Chinese characters having the inputted Bopomofo are extracted from the displayed possible second characters. Then, in the display area 136c, phrases (possible phrases) which have the first Chinese character having the shape inputted in the input space 136a and the second Chinese character having the Bopomofo inputted in the input box 136b are displayed.

In the example of FIG. 12, the second Chinese character of the phrase (phrase displayed in the display area 136c) that the user intends to enter is hard to write due to many strokes. Therefore, as illustrated in FIG. 12, the user draws the shape of the first Chinese character of the phrase and inputs the Bopomofo of the second Chinese character.

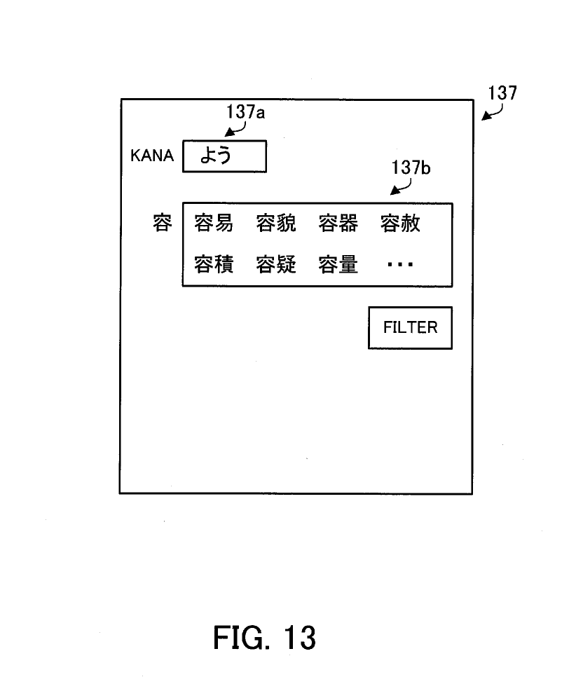

FIG. 13 illustrates a first half of a fifth example of character input. In this example, simplified Japanese characters (hereinafter, referred to as Kanji characters) are assumed to be entered. A screen 137 of FIG. 13 is an operation screen that the display control unit 125 displays on the display 112. The screen 137 has an input box 137a for input of Kana (phonetic symbols), and a display area 137b for displaying possible phrases.

When the user inputs Kana of the first Kanji character of a phrase in the input box 137a, Kanji characters having the inputted Kana are retrieved and displayed as possible first Kanji characters. In addition, possible second Kanji characters that follow each possible first Kanji character are retrieved, and possible phrases are displayed. FIG. 13 depicts the situation where the user has already determined the first Kanji character of the phrase. Alternatively, possible phrases may be displayed without determining the first Kanji character, as in the cases illustrated in FIGS. 7 and 9.

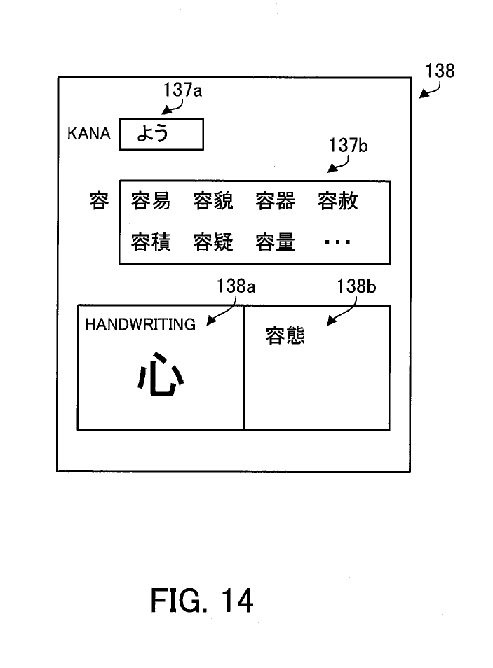

FIG. 14 illustrates a second half of the fifth example. A screen 138 of FIG. 14 is an operation screen that the display control unit 125 displays on the display 112 after the screen 137. The screen 138 has an input space 138a for handwriting of the shape of a Kanji character and a display area 138b for displaying extracted possible phrases, in addition to the input box 137a and display area 137b.

When the user enters a filter command to narrow down possible phrases on the screen 137, the input space 138a appears. When the user draws the shape of Kanji “heart” radical as part of the shape of the second Kanji character of the phrase in the input space 138a, phrases which have the second Kanji character with the Kanji “heart” radical are extracted from the possible phrases displayed in the display area 137b. Then, the extracted possible phrases are displayed in the display area 138b.

In the example of FIGS. 13 and 14, the second Kanji character of the phrase (phrase displayed in the display area 138b) that the user intends to enter has Kana of “tai” as pronunciation if used alone. On the other hand, this phrase has Kana of “you dai” as pronunciation, which means that the second Kanji character has different pronunciation if used in the phrase. That is, the second Kanji character has variant Kana pronunciations. Therefore, the Kana of the second Kanji character of the phrase is easy to be mistaken. Therefore, as illustrated in FIG. 12, the user inputs Kana of the first Kanji character of the phrase and then writes the radical of the second Kanji character.

The portable telephone 100 according to the second embodiment makes it possible to reduce the user's operational burden to enter a phrase made up of two or more Chinese characters, and realizes trouble-free phrase input. That is to say, a phrase may be entered by using both the phonetic-based input method and the handwritten shape-based input method. Even if the user does not remember the phonetic symbols of a phrase or the shape of a Chinese character correctly, possible phrases can be extracted efficiently on the basis of a vague memory for phonetic symbols or shapes.

In addition, the user is able to sequentially specify a phrase in order from the first Chinese character of the phrase with pronunciation or shape as a search condition, thereby narrowing down Chinese characters stepwise. That is to say, the user is able to enter the phrase naturally. More specifically, when the phonetic symbols (or shape) of the first Chinese character of an intended phrase are inputted, possible phrases that begin with the first Chinese character are displayed, and when the shape (or phonetic symbols) of the second Chinese character is inputted, the possible phrases are narrowed down.

Further, an ambiguous search condition may be set for a Chinese character, which results in a plurality of possible Chinese characters. Even on the basis of user's vague memory, possible phrases are extracted efficiently. Still further, to search for a Chinese character matching a handwritten shape, matching may be carried out based on the shape of a component part, without taking a stroke order into consideration. This makes it possible to increase a possibility of extracting an intended Chinese character even if the user makes stroke order mistakes.

A character input program that is executed by such a portable telephone 100 provided with a computer may be recorded on a computer-readable recording medium. Computer-readable recording media include magnetic recording devices, optical discs, magneto-optical recording media, semiconductor memories, etc. The magnetic recording devices include HDDs, Flexible Disks (FD), magnetic tapes (MT), etc. The optical discs include Compact Discs (CD), CD-R (Recordable)/RW (ReWritable), Digital Versatile Discs (DVD), DVD-R/RW/RAM, etc. The magneto-optical recording media include Magneto-Optical disks (MO) etc.

To distribute the character input program, portable recording media on which the program is recorded may be distributed. Alternatively, the character input program may be stored in a server computer and may be transferred from the server computer to the portable telephone 100 over a network. The portable telephone 100 stores in its non-volatile storage device the program read recorded on a portable recording medium or the program acquired over the network, for example. Then, the portable telephone 100 reads and runs the program from the non-volatile storage device. Also, without storing the acquired program in a non-volatile storage medium, the portable telephone 100 may sequentially put the program in the RAM 119 and run the program.

Further, according to the second embodiment, the processor 118 runs a character input program to thereby perform a character input process. Alternatively, part or all of the character input process may be realized by using dedicated hardware components.

The disclosed information terminal apparatus, character input method, and character input program make it possible to realize trouble-free input of character strings.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. An information terminal apparatus comprising:
a storage unit that stores information on a plurality of character strings and information on a pronunciation and shape of each of a plurality of characters included in the plurality of character strings; and
a search unit that receives a first input representing part or all of one of a pronunciation and shape of a character, consults the storage unit to retrieve possible character strings which have a first character matching the first input, receives a second input representing part or all of another of a pronunciation and shape of a character, and extracts possible character strings which further have a second character matching the second input, from the possible character strings retrieved in response to the first input.

2. The information terminal apparatus according to claim 1, further comprising a display unit that displays information indicating the possible character strings retrieved in response to the first input after the first input is received, and displays information indicating the possible character strings extracted in response to the second input after the second input is received.

3. The information terminal apparatus according to claim 1, wherein, with respect to each of a plurality of the first characters which are found matching the first input, the search unit retrieves the possible character strings which have said each first character.

4. The information terminal apparatus according to claim 1, wherein the possible character strings begin with the first character, and the second character follows the first character.

5. The information terminal apparatus according to claim 1, further comprising an input unit for input of part or all of the shape of a character through touch operation,
wherein the search unit retrieves the first character or the second character on the basis of an input inputted to the input unit and the information on the shape of each of the plurality of characters stored in the storage unit.

6. A character input method of an information terminal apparatus for receiving character input, the method comprising:
receiving a first input representing part or all of one of a pronunciation and shape of a character;
consulting a storage unit to retrieve possible character strings which have a first character matching the first input, the storage unit storing information on a plurality of character strings and information on a pronunciation and shape of each of a plurality of characters included in the plurality of character strings;
receiving a second input representing part or all of another of a pronunciation and shape of a character; and
extracting possible character strings which further have a second character matching the second input, from the possible character strings retrieved in response to the first input.

7. A non-transitory computer-readable medium storing a character input program causing an information terminal apparatus for receiving character input to perform a process comprising:
receiving a first input representing part or all of one of a pronunciation and shape of a character;
consulting a storage unit to retrieve possible character strings which have a first character matching the first input, the storage unit storing information on a plurality of character strings and information on a pronunciation and shape of each of a plurality of characters included in the plurality of character strings;
receiving a second input representing part or all of another of a pronunciation and shape of a character; and
extracting possible character strings which further have a second character matching the second input, from the possible character strings retrieved in response to the first input.
